(19) United States
(12) Patent Application Publication
(10) Pub. No.: US 2013/0068214 A1
(43) Pub. Date: Mar. 21, 2013

(54) METHOD OF MOUNTING GAS BURNER TO SHEET METAL OR GLASS COOKTOP

(71) Applicant: Paul Bryan Cadima, Prospect, KY (US)

(72) Inventor: Paul Bryan Cadima, Prospect, KY (US)

(73) Assignee: General Electric Company

(21) Appl. No.: 13/236,227

(22) Filed: Sep. 19, 2011

(51) Int. Cl. F24C 3/08; B23P 19/04

(52) U.S. Cl. 126/39 R; 29/428

(57) ABSTRACT

A gas burner mounting assembly for removably mounting a gas burner to a cooktop is provided. The cooktop has a top surface, a bottom surface, and at least one opening disposed therethrough. The mounting assembly includes an in-jet bracket with a portion extending through the opening and supporting the gas burner above the cooktop such that a gap is formed between the gas burner and the top surface of the cooktop. The mounting assembly is configured for implementation on cooktops of multiple thicknesses.

### BACKGROUND OF THE DISCLOSURE

The following disclosure relates generally to gas burners, and more particularly to the attachment and mounting of gas burners to cooktops. The present disclosure finds particular application in removably mounting gas burners to a sheet metal or glass cooktop.

Generally, atmospheric gas burners are used as surface units in household gas cooking appliances. Gas surface burners used in cooking products typically include a burner body including a plurality of burner ports through which a gas is distributed, and a burner cap positioned over the burner body. Although gas burners were typically used with sheet metal cooktops, recently gas burners have been used with glass cooktops to provide a smooth, easy to clean cooking surface. The different materials used for cooktops may differ in thickness depending on material. For example, glass cooktops comprise a greater thickness than the traditional cooktops comprising sheet metal. Prior mounting arrangements have attempted to adapt gas burners for use with glass cooktops by employing unique brackets or burners fabricated specifically for glass mounting. Adapter plates are optionally added between the burners to re-introduce a thin sheet metal mounting surface and maintain the current mounting interface between the burners and cooktop.

U.S. Pat. No. 6,032,662, illustrated in FIG. 1, describes one method that mounts a gas burner on an adapter plate, which is then mounted directly to a cooktop. However, this method loses the appearance of the burner being mounted directly on the glass, since the adapter plate has a larger diameter than the burner in order to maintain the mounting interfaces and relationships. Additionally, the burner head is mechanically mounted to the cooktop and cannot practically be removed for cleaning.

However, from a visual or aesthetic standpoint, it is desirable to mount gas burners such that it appears that the burners are mounted directly on the cooktop. It is also desirable to have the gas burners easily removable for cleaning purposes. The burner bodies are typically unable to be removed without the use of tools and essentially dismantling of the cooktop is required in order to clean around and beneath the gas burner. U.S. Pat. No. 5,046,447, illustrated in FIG. 2, describes an arrangement where a burner is mechanically fastened to the cooktop itself. However, as with the examples above, this method also suffers from the lack of removability for cleaning purposes.

However, in addition to the lack of burner removability, previous arrangements are not ideal since they require special mounting parts that are unique to each type of cooktop. To be practical, a mounting assembly should be adaptable for use with various cooktop materials without having to change the fundamental components of the mounting materials. U.S. Pat. No. 6,328,556, considers the variability of cooktop thicknesses and provides a burner assembly for use on both thick and thin cooktops. However, as is seen with the previous mounting assemblies, the burner is screwed into the cooktop and holder, so that the burner cannot be removed easily for cleaning without the use of tools.

Accordingly, there is a need for a gas burner mounting arrangement that enables a gas burner to be removably mounted on cooktops of various thicknesses or materials without the need for unique brackets or burners, while maintaining the appearance that the burner sits flush to the mounting surface and allowing for easy removal and cleanup.

### SUMMARY OF THE DISCLOSURE

A gas burner mounting assembly for removably mounting a gas burner to a cooktop is provided. The cooktop has a top surface, a bottom surface, and at least one opening disposed therethrough. The mounting assembly includes an in-jet bracket comprising a top portion and a cylindrical bottom portion extending downwardly from the top portion, the top portion having a circumferential outer collar and an inner collar disposed concentrically within the outer collar, wherein at least a portion of the top portion abuts the bottom surface of the cooktop. The mounting assembly further includes at least one protrusion extending from the top portion of the in-jet bracket, and a gas burner configured to be removably mounted on the cooktop such that a gap is formed between the gas burner and the top surface of the cooktop. The mounting assembly is configured for implementation on cooktops of multiple thicknesses.

A mounting assembly for removably mounting a gas burner to a cooktop is provided. The cooktop has a top surface and a bottom surface. The cooktop includes at least one of a sheet metal material and a glass material, wherein the glass material has a greater thickness than the sheet metal. The mounting assembly has an in-jet bracket comprising an outer collar and an inner collar concentrically disposed within the outer collar, wherein at least a portion of the in-jet bracket is configured to rest against the bottom surface of the cooktop, at least one protrusion extending from the in-jet bracket a greater length than either the outer or inner collar, and a gas burner configured to be partially inserted through a burner opening in the cooktop and removed for cleaning without the use of tools.

A method for removably mounting a gas burner to a cooktop is provided. The cooktop has atop surface and a bottom surface and comprises at least one of a sheet metal material undo glass material, wherein the glass material has a greater thickness than the sheet metal. The method includes attaching at least a portion of an in-jet bracket to the bottom surface of the cooktop, the in-jet bracket including a top portion and a cylindrical bottom portion extending downwardly from the top portion, the top portion having a circumferential outer collar and an inner collar disposed concentrically therein, and removably mounting a gas burner to the cooktop by inserting a portion of the burner through a burner opening disposed in the cooktop. The gas burner is mounted such that a gap is formed between the top surface and the burner.

### BRIEF DESCRIPTION OF THE DRAWINGS

FIGS. 1 and 2 illustrate prior art gas burner mounting arrangements.

FIG. 3 is a perspective view of an oven range.

FIG. 4 is an exploded perspective view of a burner assembly.

FIG. 5 illustrates an exemplary in-jet bracket in accordance with one aspect of the present disclosure.

FIG. 6 illustrates an exploded perspective view of a gas burner mounting assembly for mounting a gas burner on a glass cooktop.

FIG. 7 illustrates a cross-sectional view of one exemplary gas burner ounting assembly for mounting a gas burner on a glass cooktop.

FIG. 8 illustrates an exploded perspective view of a gas burner ounting assembly for mounting a gas burner on a metal cooktop.

FIG. 9 illustrates a cross-sectional view of one exemplary gas burner mounting assembly for mounting a gas burner on a metal cooktop.

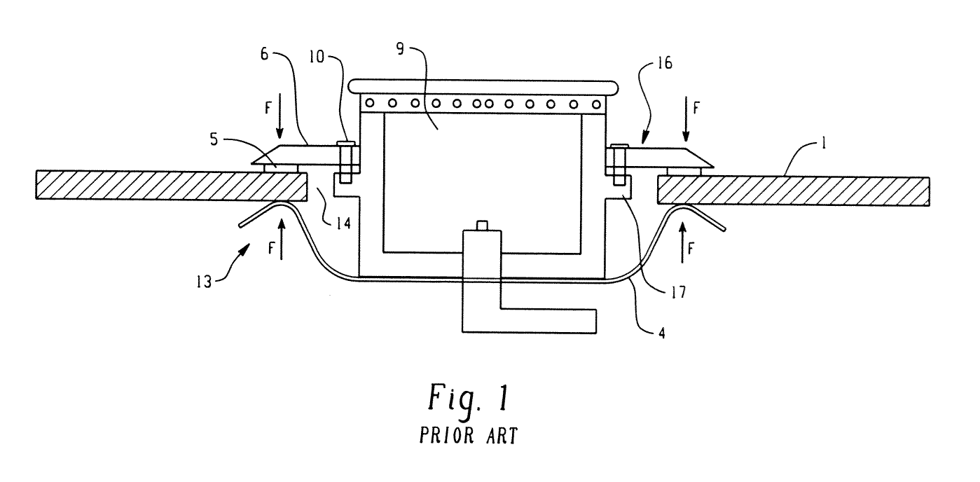

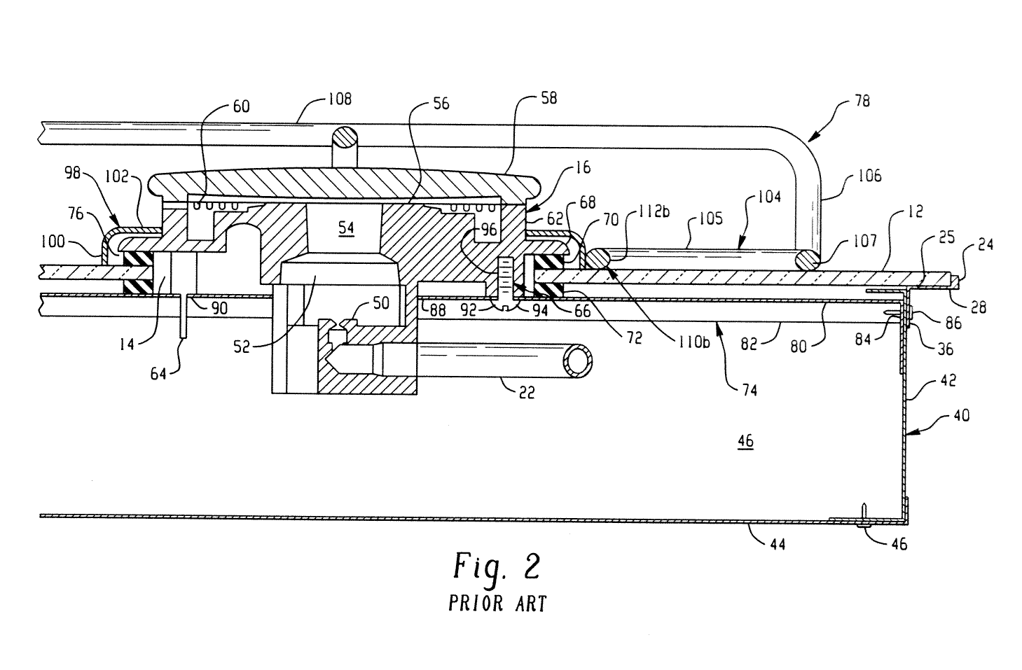

### DETAILED DESCRIPTION OF THE PREFERRED EMBODIMENTS

While methods and apparatuses are herein described in the context of a gas-fired cooktop, as set forth more fully below, it is contemplated that the described methods and apparatuses may find utility in other applications, including, but not limited to, gas heater devices, gas ovens, gas kilns, gas-fired meat smoker devices, and gas barbecues. In addition, these principles and teachings may find equal applicability to combustion burners for a variety of combustible fuels. The following description is therefore set forth only by way of illustration rather than limitation.

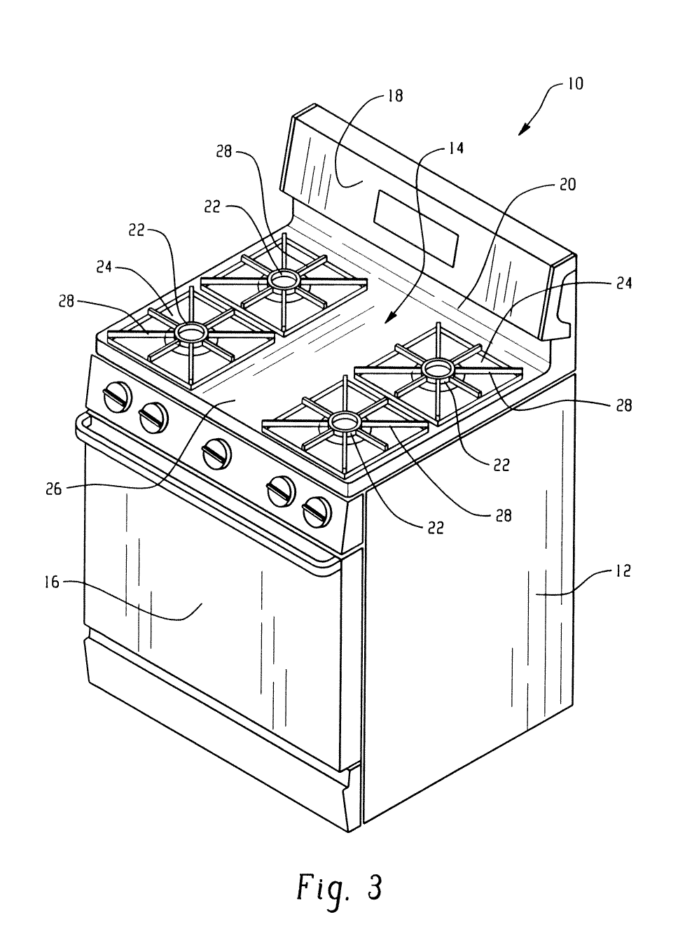

FIG. 3 illustrates an exemplary free standing gas range in which the described methods and apparatuses may be practiced. Range 10 includes an outer body or cabinet that incorporates a generally rectangular cooktop 14. An oven, not shown, is typically positioned below cooktop 14 and has a front-opening access door 16. A range backsplash 18 extends upward of a rear edge 20 of cooktop 14 and contains various control selectors (not shown) for selecting operative features of heating elements for cooktop 14 and the oven. The present description applies not only to cooktops which form the upper portion of a range, such as range 10, but to other forms of cooktops as well, such as, but not limited to, free standing cooktops that are mounted to a kitchen counter. Therefore, gas range 10 is provided by way of illustration rather than limitation, and accordingly there is no intention to limit application of the present disclosure to any particular appliance or cooktop, such as range 10, or cooktop 14.

Cooktop 14 preferably includes four gas fueled burner assemblies 22 which are usually positioned in spaced apart pairs positioned adjacent each side of cooktop 14. Each pair of burner assemblies 22 is surrounded by a recessed area 24 of cooktop 14. Recessed areas 24 are positioned below an upper surface 26 of cooktop 14 and serve to catch any spills from cookware or cooking utensils used with cooktop 14. Each burner assembly 22 extends upwardly through an opening in recessed areas 24, and a grate 28 is positioned over each burner 22. Each grate 28 typically includes a flat surface thereon for supporting cookware and utensils over burner assemblies 22 for cooking or meal preparations placed therein.

The construction and operation of the range heating elements, including cooktop gas burner assemblies 22, are believed to be within the purview of those in the art without further discussion, and as details of the range heating elements are generally beyond the scope of the herein described methods and apparatuses, further description is therefore omitted.

While cooktop 14 includes two pairs of grates 28 positioned over two pairs of burner assemblies 22, a greater or lesser number of grates could be employed with an associated greater or lesser number of burners without departing from the scope of the present disclosure.

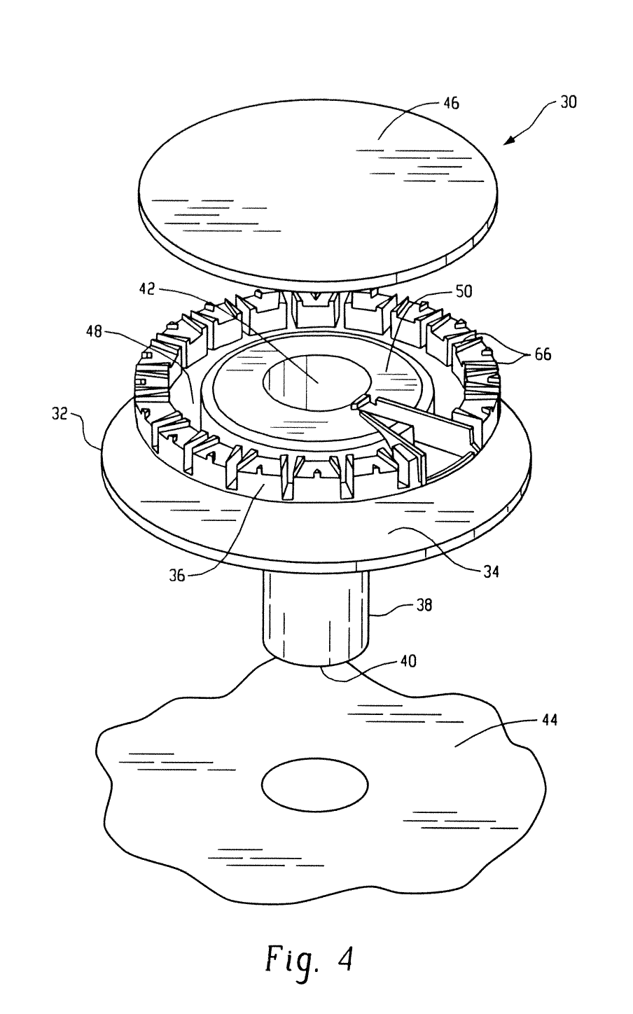

FIG. 4 is an exemplary exploded perspective view of a typical burner assembly that can be used with the gas range of FIG. 3. The burner assembly includes a burner body 32, a solid base portion 34, and a cylindrical sidewall 36 extending axially from the periphery of base portion 34. A main gas conduit 38 having an entry area 40 and a burner throat region 42 is open to the exterior of burner body 32 and defines a passage that extends axially through the center of burner body 32 to provide fuel/air flow to the burner assembly 30. As used herein, the term “gas” refers to a combustible fuel or gas, or gaseous fuel-air mixture.

Burner assembly 30 is mounted on a support surface 44, such as cooktop 14, of a gas cooking appliance such as a range or cooktop. A cap 46 is disposed over the top of the burner body 32, defining therebetween an annular main fuel chamber 48 and annular diffuser region (not shown). A generally torodial-shaped upper portion 50 of burner body 32, immediately bordering burner throat 42, in combination with cap 46 defines the annular diffuser region therebetween. Cap 46 can be fixedly attached to the sidewall 36 or other designated attachment point or can simply rest on sidewall 36 for easy removal. More specific details of the structure and function of the burner assembly shown in FIG. 4 are provided in commonly owned U.S. Pat. No. 7,017,572.

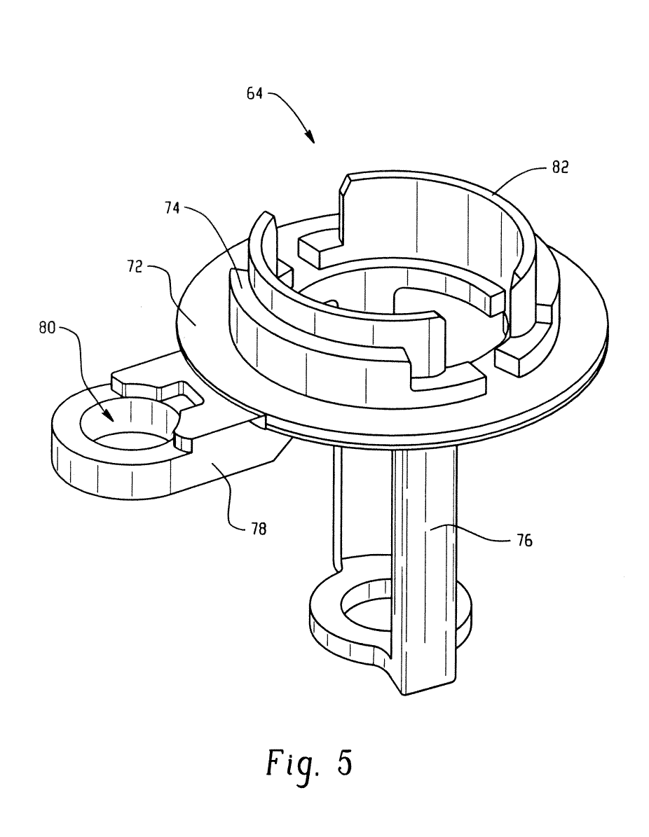

Turning to the present disclosure, the embodiment of FIGS. 5-9 shows a burner mounting assembly 60 that enables a single surface gas burner 62 to be removably mounted on multiple cooktops comprising materials with differing thicknesses, such as glass and thin steel sheet metal, that is easily removable for cleaning. Typically, when gas burners are mounted to a cooktop, the burners are screwed down to permanently attach the gas burners to the glass and the burners are not easily removable for cleaning or replacement. These burners are generally gasket sealed and are immoveable; therefore, as the burners are used and spills occur, there is no effective way to clean the burners. In some cases, there is a gap between the burner and the glass itself that is not large enough to clean beneath, and the burner is unable to be removed without tools. Accordingly, if there is a spill under the burner, the spill remains unless tools are used to dismantle the burner. Therefore, the present burner mounting assembly 60 provides the ability to mount a gas burner 62 to a cooktop 66, 67 such that the burners 62 can be lifted and removed for cleaning. Additionally, the arrangement allows for the burners 62 to mount to both a thick glass cooktop 67 and a thin sheet metal cooktop 66 without the need for the implementation of different mounting parts.

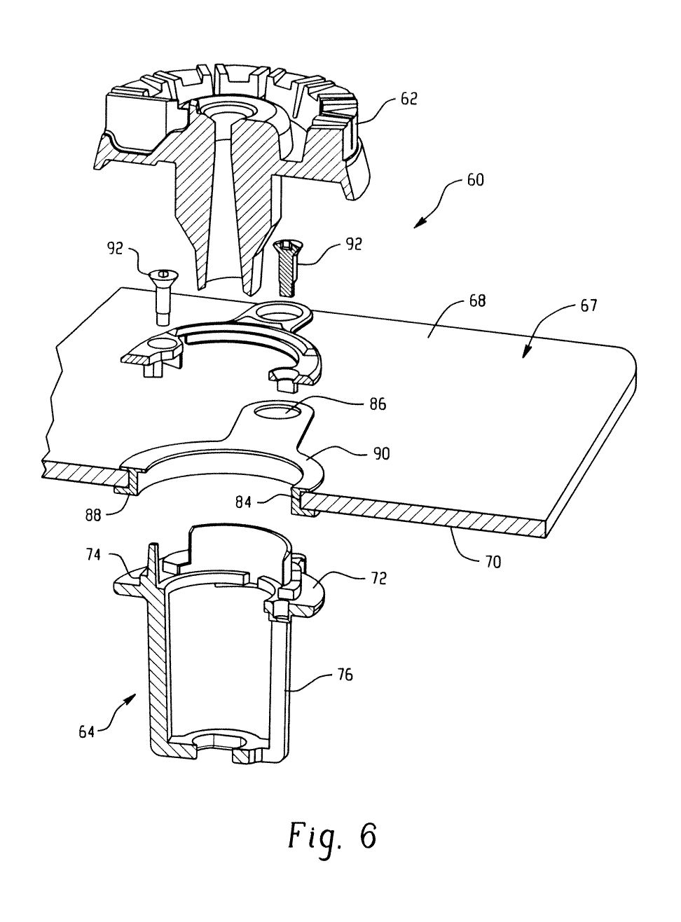

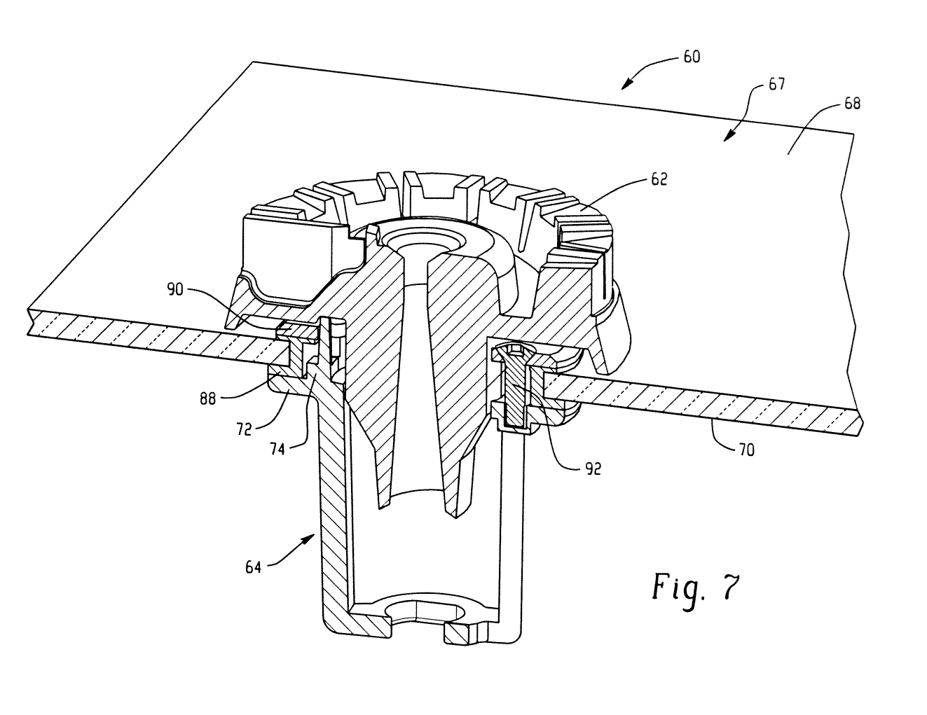

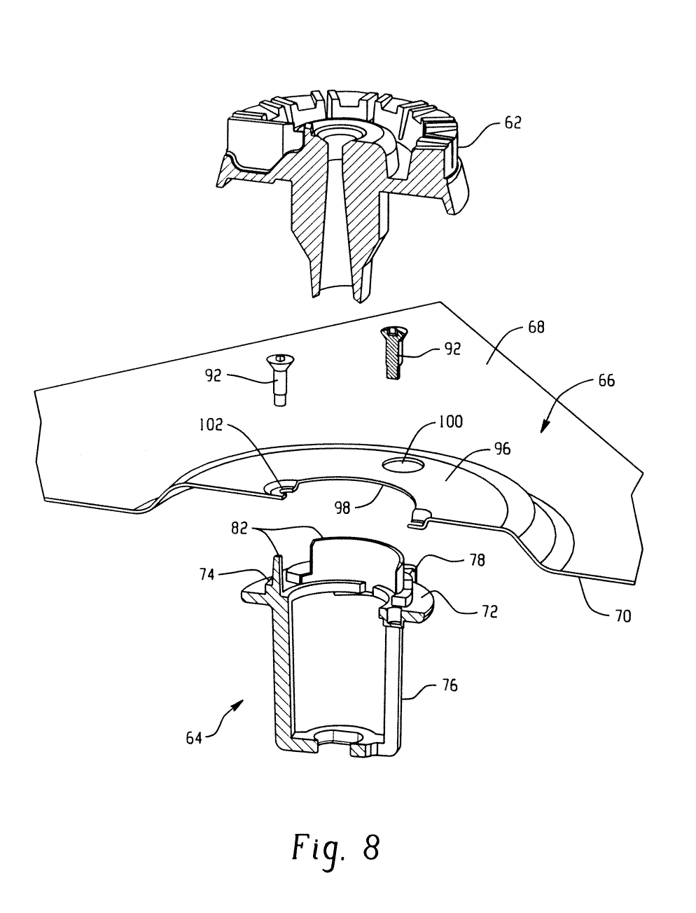

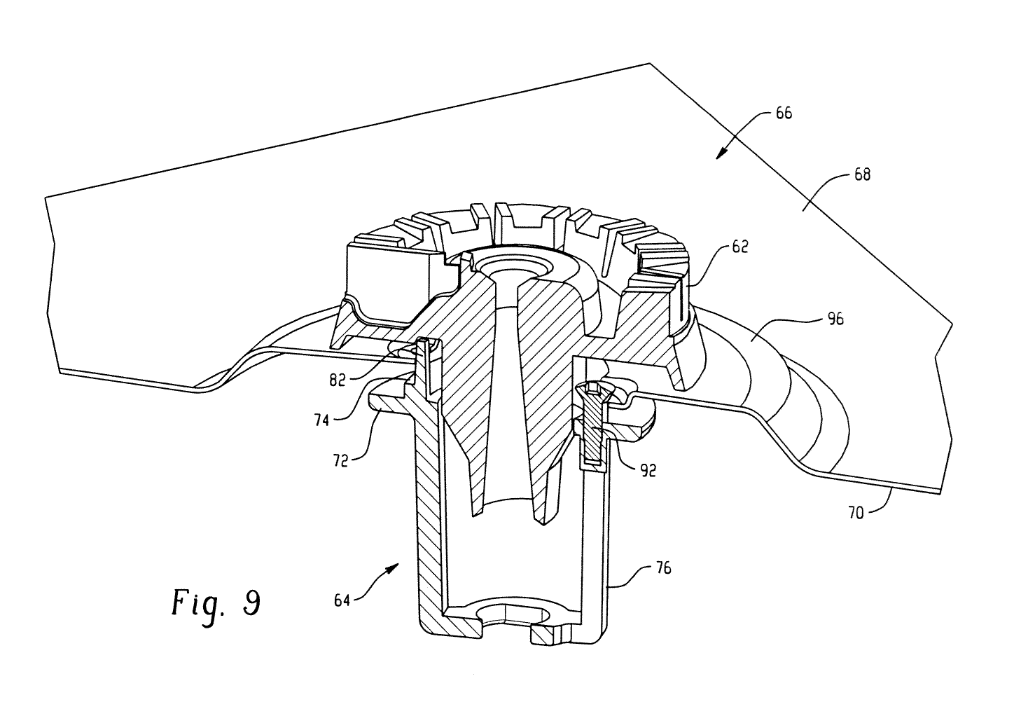

FIGS. 6-9 illustrate an exemplary mounting assembly 60 adapted for use on multiple cooktops comprising different materials, such as glass 67 (FIGS. 6-7) and steel (FIGS. 8-9) cooktops. The cooktops may be of multiple thicknesses and include a top surface 68 and a bottom surface 70. The mounting assembly 60 includes an in-jet bracket 64 (FIG. 5) that rests adjacent to the glass 67 and metal 66 cooktops from the underside of the cooktop 66, 67.

As best seen in FIG. 5, the in-jet bracket 64 includes a top portion comprising two concentric, circular collars 72, 74, each extending at different heights, and a generally cylindrical rod-like extension 76 extending downwardly from the collar portions. The outer collar portion 72 comprises a flat rim-like extension forming a circumferential rim around the top of the in-jet bracket 64. The outer collar portion 72 is designed to rest adjacent the underside 70 of a glass cooktop 67 (FIG. 7) as will be described in greater detail below. Extending from the outer collar portion 72, a projecting min 78 is provided with at least one through opening or hole 80 for holding an igniter (not shown) that may be inserted from above. The inner collar portion 74 extends concentrically within the outer collar portion 72 and includes at least one protrusion 82 that has a greater length than the remaining inner collar portions 74. The protrusions 82 are designed to protrude above the top surface 68 of a cooktop to removably support a gas burner 62 (FIGS. 7 and 9) and establish a ground path between the burner 62 and the in-jet bracket 64, which is grounded to the appliance chassis via gas supply tubing (not shown). The protrusions 82 preferably extend at a height relative to the inner 74 and outer 72 collars such that the gas burner 62 will rest at a fixed height above the metal 66 or glass 67 cooktop upper surface 68 without the need for unique brackets or additional parts. The inner collar 74 is designed to rest up against the underside 70 of a metal cooktop 66, with the protrusions 82 extending through holes provided in the cooktop material.

In-jet bracket 64 is designed such that may be implemented for use with cooktop surfaces having different thicknesses such as glass or metal cooktop surfaces. As illustrated in the exemplary embodiment of FIGS. 6-7, the glass cooktop 67 has a thickness generally less than about 5 mm, and particularly, about 4 mm, although the present disclosure is not limited to these particular dimensions. Even in the event the in-jet bracket 64 is being used with a thicker cooktop 67, the burner 62 mounts to the in-jet bracket 64 with a slight gap between the burner 62 and the glass cooktop top surface 68.

In FIGS. 6 and 7, an exemplary gas burner mounting assembly 60 includes a gas burner 62 mounted to a glass cooktop 67. More specifically, the glass cooktop 67 includes a burner opening 84 and smaller igniter opening 86 offset from the burner opening 84. A bottom gasket 88 and top gasket 89 are inserted into the burner opening 84, followed by an adapter plate 90. The bottom gasket 88 is provided between the glass cooktop 67 and the in-jet bracket 64 to mate the surfaces and create a sealed arrangement. Additionally, since the burner opening 84 has a generally large diameter, the adapter plate 90 and top gasket 89 are provided to establish a seal for any spills that may take place and also to secure the in-jet bracket 64 to the glass cooktop 67. The burner opening 84, gaskets 88, 89, and adaptor plate 90 are preferably sized so that the inner collar portion 74 of the in-jet burner 62 extends therethrough (FIG. 7) and the adaptor plate 90 and the outer collar 72 are brought into clamping engagement adjacent upper and lower surfaces of the glass cooktop surface, respectively. The gaskets 88, 89 separate the adaptor plate and the outer collar from the surfaces of the cooktop surface. Prior to inserting the in-jet bracket 64, one or more fasteners such as screws 92 are inserted through openings in the adapter plate 90 and into threaded fastener openings in the in-jet bracket 64 located below the surface 68 of the glass cooktop 67. Tightening the fastener screws 92 secures both the adapter plate 90 and in-jet bracket 64 to the cooktop surface 68. The burner body 62 is then inserted over the adapter plate 90, with the gas conduit extending through the burner opening. The burner rests on the in-jet bracket (particularly illustrated as resting on the protrusions 82 of the bracket) which causes the burner to sit above the surface of the cooktop, such that there is a slight gap between the upper surface of the cooktop and the burner. The burner could alternatively rest on the adapter plate 90, although such an arrangement is not as desirable since the plate may not rest perfectly flat which could result in undesired tilting of the burner, and could also result in different gaps forming between the burner and the cooktop surface. Preferably, the gas burner 62 has a diameter larger than the adapter plate 90 in order to maintain the appearance that the burner is mounted directly to the glass surface. In this manner, the gas burner 62 is removably mounted to the in-jet bracket 64, such that the burner 62 can be removed without tools, for cleaning and other such purposes.

In FIGS. 8-9, the gas burner 62 is mounted to a traditional thin steel cooktop 66. Generally, steel cooktops 66 have a thickness of less than one inch, and particularly about 0.032″. The in-jet bracket 64 of the present mounting assembly 60 is designed to support and provide a seat for a gas burner 62 such that the burner 62 rests on the in-jet bracket 64 slightly above the cooktop surface 68, forming a small gap between the cooktop surface 68 and the burner 62. This gap is preferably minimal to allow the burner 62 to appear as if the burner is resting directly on the cooktop top surface 68, while ensuring that the burner 62 only forms a connection with the in-jet bracket 64 so as to ensure a ground path to the in-jet bracket.

FIG. 8 illustrates a perspective view of the burner mounting assembly 60 for use with metal cooktops 66, which are generally thinner than the glass cooktops 67 described above. The metal cooktop 66 includes an embossed or raised portion 96 in the cooktop surface 66. Generally at the center of the embossed portion 96, a small burner opening 98 is provided, along with an igniter opening 100, and one or more fastener openings 102 disposed around the burner opening 98. One or more protrusions 82 included on the inner collar 74 are designed such that, as the in-jet bracket 62 is placed against the underside 70 the metal cooktop 66, the protrusions 82 extend up through the burner opening in the cooktop 66 to provide a mounting support for the gas burner 62.

The protrusions 82 of the in-jet bracket are intended to contact and support the burner body 62, and form a conductive path therewith. This conductive connection electrically grounds the burner 62 in order for the spark from an igniter to spark to the burner. The gas burner 62 does not sit directly on the cooktop, since glass and enameled steel, for example, are not conductive. It is not preferred that the burner contact both the cooktop and the in-jet bracket, since this would require a perfect assembly each and every time, which is difficult to achieve. Accordingly, in one embodiment, the protrusions 82 should be a length greater than the maximum thickness of a cooktop 66, 67 upon which mounting is intended to allow for a gap to form between the burner and the cooktop surface. For example, if the burner mounting assembly 60 is intended to be mounted on a glass cooktop 67 with a thickness of about 4 mm plus the combined thickness of the adapter plate and the compressed gasket, the protrusions 82 should extend from the collar a length greater than this combined dimension to allow the burner to rest on the protrusions 82 and form a gap between the burner 62 and the cooktop 66, 67. The gap is minimal, so that it appears that the burner 62 is resting directly on the cooktop surface 68, even though the burner is not actually touching the surface, but instead is supported by the in-jet bracket 64. The in-jet bracket holds an igniter that extends through opening 100 in the metal cooktop surface (FIG. 8) to associate with and spark the burner, or that extends through the opening 86 in the glass cooktop surface (FIG. 6).

In addition, the present disclosure should not be limited to the arrangement described above where the protrusions 82 extend above the top surface of the cooktop. Rather, the present disclosure also contemplates that the burner may be supported above the top surface of the cooktop as a result of the burner resting on a surface of the in-jet bracket that is positioned below the cooktop in a manner that still supports the burner body 62 and forms a conductive path therewith.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. A gas burner mounting assembly for removably mounting a gas burner to a cooktop, said cooktop having a top surface, a bottom surface, and at least one opening disposed therethrough, said mounting assembly comprising:
an in-jet bracket comprising a top portion and a bottom portion extending downwardly from said top portion;
a gas burner configured to be removably supported by the in-jet bracket such that a gap is formed between the gas burner and the top surface of said cooktop, and
wherein said mounting assembly is configured for implementation on cooktops of multiple thicknesses.

2. The gas burner mounting assembly of claim 1, wherein said gas burner is configured to be removed from said mounting assembly without the use of tools.

3. The gas burner mounting assembly of claim 1, wherein said in-jet bracket further includes a projecting arm extending outwardly from said top portion, wherein said projecting arm comprises at least one through hole for holding an igniter.

4. The gas burner mounting assembly of claim 1, wherein said mounting assembly is configured to be implemented on a metal cooktop.

5. The gas burner mounting assembly of claim 1, wherein said mounting assembly is configured for use on a glass cooktop.

6. The gas burner mounting assembly of claim 5, wherein said inner collar extends through said burner opening and said outer collar is disposed adjacent the bottom surface of said cooktop.

7. The gas burner mounting assembly of claim 5, further including an adapter plate disposed on said top surface of said cooktop and operatively mounted to the in-jet bracket.

8. The gas burner mounting assembly of claim 7, further comprising a gasket mounted along the burner opening and a mount for said in-jet bracket.

9. A mounting assembly for removably mounting a gas burner to a cooktop, the cooktop having a top surface and a bottom surface, said cooktop comprising at least one of a metal material and a glass material, wherein said glass material has a greater thickness than said sheet metal, said mounting assembly comprising:
an in-jet bracket comprising an outer collar and an inner collar substantially concentrically disposed within said outer collar; and
a gas burner configured to be partially inserted through a burner opening and supported above said cooktop by the in-jet bracket and removed for cleaning without the use of tools.

10. The mounting assembly of claim 9, wherein said cooktop comprises a metal material with at least one opening for accepting a portion of the in-jet bracket therethrough.

11. The mounting assembly of claim 10, wherein the in-jet bracket includes an inner collar that limits movement of the bracket through the opening rests against the bottom surface of the cooktop.

12. The mounting assembly of claim 11, wherein said gas burner is configured to removably mount to said in-jet bracket and form a gap between the top surface of the cooktop and the burner.

13. The mounting assembly of claim 9, wherein said cooktop comprises a glass material with an adapter plate disposed thereon and a gasket sealing the burner opening.

14. The mounting assembly of claim 13, wherein a portion of the in-jet bracket is dimensioned into said burner opening and attachment to said adapter plate, such that said outer collar is dimensioned to operatively engage against the bottom surface of the cooktop.

15. The mounting assembly of claim 13, wherein said gas burner is mounted on the in-jet bracket and a gap is formed between the gas burner and the top surface of the cooktop.

16. The mounting assembly of claim 13, wherein said adapter plate has an opening for receiving a fastener that extends through the burner opening in the cooktop and operatively engages the in-jet bracket.

17. The mounting assembly of claim 13, further including a gasket disposed within said burner opening.

18. A method for removably mounting a gas burner to a cooktop, the cooktop having a top surface and a bottom surface and comprises at least one of a metal material and a glass material, wherein said glass material has a greater thickness than said metal, said method comprising:
positioning an in-jet bracket along the bottom surface of said cooktop, said in-jet bracket comprising a portion extending through a burner opening in the cooktop;
removably mounting a gas burner to the cooktop by inserting a portion of the burner through the burner opening disposed in said cooktop for support by the in-jet bracket, wherein said gas burner is mounted such that a gap is formed between said top surface and said burner.

19. The method according to claim 18, wherein implementation on a glass cooktop further includes mounting an adapter plate on the top surface of the cooktop that fastens to the in-jet bracket.

20. The method according to claim 18, wherein implementation on a metal cooktop further includes fastening the in-jet bracket to the metal cooktop.
